(19) United States
(12) Patent Application Publication
(10) Pub. No.: US 2014/0279809 A1
(43) Pub. Date: Sep. 18, 2014

(54) Data Broker Reasoner

(71) Applicant: Raytheon Company, Waltham, MA (US)

(72) Inventors: Paul C. Hershey, Ashburn, VA (US); William J. Kyker, Fairfax, VA (US); Donald H. Leonard, Herndon, VA (US); Jason Dudash, Arlington, VA (US); Douglas E. Toppin, Ashburn, VA (US); Christopher J. Graham, Bethesda, MD (US); Mu-Cheng Wang, Acton, MA (US); Steven A. Davidson, Acton, MA (US)

(73) Assignee: Raytheon Company, Waltham, MA (US)

(21) Appl. No.: 14/109,059

(22) Filed: Dec. 17, 2013

Related U.S. Application Data
(60) Provisional application No. 61/793,781, filed on Mar. 15, 2013.

(51) Int. Cl. G06N 5/02

(52) U.S. Cl. CPC G06N 5/025
USPC 706/47

(57) ABSTRACT

A data broker-reasoner (DBR) system for automating mission planning and execution includes a context originating entity, a reasoner/decision entity, and a plurality of enforcement entities. The context originating entity extracts mission policy information from a variety of source materials, including checklists, manuals, and other documentation. The reasoner/decision entity interprets the mission policy in the context of situational awareness (SA) events to determine which policies should be enforced. Each of the enforcement entities is configured to enforce various policies within the context of a given mission lifecycle phase by providing commands, data, and requests to a plurality of user applications and/or other mission systems. The DBR can operate autonomously or semi-autonomously.

### CROSS REFERENCE TO RELATED APPLICATIONS

This application claims the benefit under 35 U.S.C. §119(e) of U.S. Provisional Application No. 61/793,781 filed Mar. 15, 2013, which application is incorporated herein by reference in its entirety.

### BACKGROUND

As is known in the art, mission planning and execution are complex processes involving many interdependent systems and personnel. Typically, a mission lifecycle is broken into several phases, such as pre-mission, launch and recovery (L&R), on-mission, maintenance, and post-mission, each having its own policies and procedures that must be followed to ensure success of the mission. During any of the several mission phases, commanders and support personnel are tasked with comprehending a complex set of policies and procedures, interpreting vast amounts of real-time situational data, and quickly making decisions that affect the mission outcome. Thus, systems are needed which automate mission planning and execution.

### SUMMARY

Sought to be protected herein is a data broker-reasoner (DBR) system comprising: a context originating entity for receiving mission source information from one or more information sources and for outputting a mission policy; a reasoner/decision entity, coupled to the context originating entity, for receiving a new mission policy from the context originating entity, for receiving event data, for determining an enforcement rule based upon the new mission policy and the event data, and for outputting the enforcement rule; and one or more enforcement entities, coupled to the reasoner/decision entity, for receiving an enforcement rule from the reasoner/decision entity and executing the received enforcement rule. Each of the enforcement entities may correspond to a mission lifecycle phase.

In accordance with one aspect, the context originating entity comprises: an ontology database configured to store ontologies; a parser coupled to the ontology database and configured to fetch ontologies from the ontology database; and a policy editor coupled to the ontology database and the parser and configured to receive intent commands from a user, generate an ontology based upon the intent commands, generate a mission policy based upon the intent commands and the ontology, and send the policy to the parser.

In one aspect, the reasoner/decision entity comprises: a policy database; a policy integration module coupled to the policy database and configured to receive the new mission policy, fetch an existing mission policy from the policy database, and integrate the new mission policy with the existing mission policy; an event collector-analyzer for receiving event data from one or more data sources; and a context manager, coupled to the policy integration module and the event collector-analyzer, for receiving a plurality of mission policies from the policy integration module, for receiving event data from the event collector-analyzer, for selecting one of the plurality of mission policies to be enforced, and for outputting an enforcement rule associated with the selected mission policy.

In one aspect, at least one of the enforcement entities includes: a mission requirements database; a configuration manager, coupled to the mission requirements database, to receive mission requirements from a user and to store the mission requirements in the mission requirements database; a resource manager to manage resources information; a mission plans database configured to store mission plans; a decision engine, coupled to the configuration manager, the mission plans database, and the resource manager, the decision engine configured to receive current requirements from the configuration manager, receive resource information from the resource manager, fetch a plurality of mission plans from the mission plans database, and select one of the plurality of mission plans based upon the current requirements and the resource information; and an effective rules database coupled to receive rules updates from the configuration manager and coupled to provide rules to the decision engine.

In one aspect, the DBR system further comprises a mission-related resources database coupled to provide resource information to the resource manager and to receive resource information updates from the resource manager.

In some aspects, the reasoner/decision entity further comprises: a system resource data source; a system resource manager coupled to the system resource database and the system resource data source, the system resource manager operable to receive resource information from the system resource data source; and a system resources database coupled to the system resource manager, the policy integration module, and the event collector-analyzer, the system resources database operable to receive resource updates from the event collector-analyzer, resource reservations from the policy integration module, resource updates from the system resources manager, and to provide available resource information to the policy editor and the parser.

In one aspect, the DBR system further comprises: an Event-Condition-Action (ECA) rule translation database; a rules database; a policy translation module coupled to receive defined rules from the ECA rule translation database and coupled to receive one or more newly active policies from the context manager; a conflict detection and rule integration module coupled to provide updated rules to and receive existing rules from the rules database, coupled to receive ECA rules from the policy translation module, and coupled to provide feedback to the context manager; and an operator enable/override module coupled between the context manager and the policy translation module, the operator enable/override module operable to allow a user to make real-time policy decision and override policy decisions made by the context manager.

Further sought to be protected herein is a mission planning system, comprising: one or more mission lifecycle databases; one or more mission applications; and a DBR system coupled to the mission lifecycle databases and to the mission applications.

### BRIEF DESCRIPTION OF THE DRAWINGS

Various embodiments of the invention may be more fully understood from the following detailed description of the drawings, in which:

FIG. 1 is a block diagram of a mission planning and execution system, which includes a data broker-reasoner (DBR); and

FIGS. 2A and 2B, collectively referred to herein as FIG. 2, are block diagrams of an exemplary DBR architecture; and

FIG. 3 is a schematic representation of an exemplary processing apparatus for use with the DBR of FIG. 1.

### DETAILED DESCRIPTION

Before describing embodiments of the concepts, systems, and techniques sought to be protected herein, some introductory concepts and terminology are explained.

As used herein, the terms “mission context” and “context” are used to describe any environmental or temporal change that may affect a mission plan. The term “context-based rule” means a rule that refers to some mission context. As used herein, the term “qualified event” is an event that resides within the set of possible events that require system attention during a mission.

The systems, concepts, and techniques sought to be protected are described hereinbelow for use in particular types of missions, such as unmanned aerial vehicle (UAV) surveillance missions. However, it should be understood that these concepts, systems, and techniques can be used to automate the planning and execution of many different types of military, governmental, and civilian missions and is thus not limited to any particular type of mission.

As used herein, the term “entity” is used to describe a circuit (e.g. an electronic circuit such as a processor) or module that performs a function, an operation, or a sequence of operations. The function, operation, or sequence of operations can be is hard coded into the electronic circuit or soft coded by way of instructions held in a memory device. A processor can perform the function, operation, or sequence of operations using digital values (e.g. digital signal processor (DSP) circuit) or using analog signals.

In some embodiments, the processor can be embodied in or realized as an application specific integrated circuit (ASIC), which can be an analog ASIC or a digital ASIC. In some embodiments, the processor can be embodied in or realized as a microprocessor with associated program memory. In some embodiments, the processor can be embodied in or realized as a discrete electronic circuit, which can be analog or digital.

As used herein, the terms “database” and “repository” are both used to refer to any suitable non-transitory data storage facility, including a file-based storage facility embedded within a user application, a database server physically and/or logically separate from the user application, and/or a database management system. Suitable databases/repositories for use in the present systems include, for example, relational database management systems (RDBMS), key/value stores, and object-based database systems. The several databases/repositories described herein may share one or more common physical and/or virtual computing platforms.

It should be noted that where computer software can be used, many routine program elements, such as initialization of loops and variables and the use of temporary variables are not described. It will be appreciated by those of ordinary skill in the art that unless otherwise indicated herein, the particular sequence of processes implemented by the entities is illustrative only and can be varied without departing from the spirit of the concepts, systems and techniques disclosed herein.

Referring to FIG. 1, a data broker-reasoner (DBR) 100 receives information from and provides information to systems involved in a mission life cycle 102. In the exemplary embodiment of FIG. 1, the mission lifecycle includes a pre-mission phase 102a, a launch and recovery (L&R) phase 102b, an on-mission phase 102c, a maintenance phase 102d, and a post-mission database phase 102e, each of which includes corresponding mission lifecycle databases (also referred to herein as “mission databases” or simply “databases”) 102a-102e. The databases may, for example, be provided as part of a corresponding database management system. The DBR 100 also receives information from and provides information to one or more applications, generally denoted 104. In the exemplary embodiment, the applications 104 include a mission planner 104a, a preflight checklist 104b, a flight control application 104c, a system fault record application 104d, and an image analysis application 104e. In addition, the DBR 100 may receive situational awareness (SA) event data from one or more data sources (not shown).

The DBR 100 is discussed in detail below in conjunction with FIG. 2. In general, however, the DBR 100 may be a standalone application or may be part of an Intelligent Mission Control (IMC) 106 application. In one embodiment, the DBR 100 is provided as a service (e.g. a web service) and the IMC 106 (and/or applications 104a-104e) communicates with the DBR 100 over a network, which can be a direct point-to-point connection, a local area network, or a wireless network. As will be described in detail below, the DBR 100 receives the information provided thereto and provides whole-mission support for a mission (e.g. a UAV surveillance mission). In particular, DBR 100 comprehends a complex set of policies and procedures, interprets real-time SA data, and rapidly makes decisions that affect the mission outcome.

The pre-mission database 102a includes all information required to commence a mission, such as a catalogue of pre-determined mission plans, a pre-mission checklist, manuals for the aerial vehicle, and any other information required to get the vehicle from a hangar to a runway. The L&R database 102b includes information needed to launch and recover the vehicle. The on-mission database 102c includes information to control the vehicle during flight and perform real-time mission analysis. The maintenance database 102d includes information to diagnose and repair problems with the aerial vehicle. The post-mission database 102e includes information to perform detailed analysis of mission data.

In general, each of the applications 104a-104e may receive mission-related information and commands from the DBR 100 and/or provide intent or feedback to the DBR 100. Each application 104a-104e may include a user interface (UI) to display mission status information to a user and/or prompt a user for intent/feedback input. The applications 104 may be distributed across various types of stationary and mobile computing devices, such as workstations located in a main operations base (MOB), laptops located in a forward operating base (FOB), and tablet computers or smartphones used by field personnel such as mechanics and pilots. Thus, mission planning and execution are generally distributed processes which involve various personnel (herein referred to as “actors”) and systems and, as will be appreciated hereinbelow, the DBR 100 improves, and ideally optimizes, this process by identifying mission relevant information (e.g. data, requests, and commands) and distributing this information to the appropriate applications and actors.

In one embodiment, one or more of the exemplary applications 104a-104e are included within an Intelligent Mission Console (IMC) 106. The IMC may have a touchscreen-based UI and may be configured to run on a mobile computing device, including but not limited to a tablet computer, smart phone, laptop computer, netbook, or other mobile device. The mobile computing device may have one or more sensors, including but not limited to optical and audio devices and systems (e.g. a camera and a microphone), each of which may serve as data source to the applications 104 and/or the DBR 100. In embodiments, the mobile computing device may be used to provide augmented reality (AR), as discussed further below.

A mission commander or other authorized person is responsible for selecting an initial mission plan based upon given requirements and objectives, environmental conditions, resource availability, and any other mission context. Moreover, the commander is responsible for updating the mission plan as context changes. Thus, in one embodiment, the mission planner 104a allows the mission commander to view a plurality of available mission plans (which may be stored in the pre-mission database 102a), select an initial mission plan for use in the mission, and update the mission plan as needed. In other embodiments (discussed further below), the DBR 100 autonomously selects and updates the mission plan, and thus the mission planner 104a may be used merely for informational purposes, that is allowing the commander view the current plan. In another embodiment, the DBR 100 operates in a semi-autonomous mode in which the commander (or some other actor) can override the mission plan via the mission planner 104a.

Standard operating procedures may require that a pre-flight checklist (i.e. a list of tasks) must be completed prior to launch. Example pre-flight tasks include running vehicle self-tests, visually inspecting the vehicle, visually inspecting a runway, checking weather reports, inspecting weapons systems, and testing onboard communications systems and other avionics. It should be appreciated that a pre-flight checklist may require input from multiple actors at various locations. For example, prior to launching an unmanned aerial vehicle (UAV), a mechanic inspects the UAV, a “hawk-eye” pilot located in a chase vehicle visually inspects the runway, and a L&R pilot located in a FOB validates the proposed departure flight path. Additional pre-flight tasks and actors may be desired or even required. Therefore, it should be understood that completing a pre-flight checklist is a distributed process.

The pre-flight checklist application 104b, in coordination with the DBR 100, can streamline the pre-mission phase by automating certain tasks and coordinating tasks among the various actors. In one embodiment, one or more actors are equipped with a mobile processing device which executed the pre-flight checklist application 104b. The DBR 100 delegates tasks to each actor/application and, based upon external events, the checklist application 104b returns task-related information to the DBR 100 such that the DBR can determine when the pre-flight checklist is complete. Some tasks are completed entirely by the actor and the checklist application 104b simply allows the actor to record when a task has been completed. Other tasks can be entirely or partially automated. For example, a visual inspection task may involve a mechanic taking pictures of the UAV body and wheels using an imaging device (e.g. a tablet's camera) and the checklist application 104b can compare those actual images to exemplary images stored in the pre-mission database 102a. If the images are dissimilar, application 104b may record (or “mark”) the task as failed.

In a one embodiment, the DBR 100 halts the mission if any task fails. In other embodiments, the DBR 100 attempts to reconcile the problem using its reasoning capabilities. For example, if the UAV direction finder does not pass its self-test, the system fault record application 104d can access information (e.g. an electronic manual) stored in the maintenance database 102d which describes the direction finder. The application 104d interprets this information and enables the DBR 100 to make a decision based upon its rules whether the vehicle should take off or whether the system in question (in this example, the UAV direction finder) must be replaced. If all pre-flight checklists tasks are completed without fault, the DBR 100 may transition from the pre-mission phase to the L&R phase.

The flight-control application 104c can be used by a hawk-eye pilot, a L&R pilot, or a control pilot to control the UAV in flight. In addition to basic flight control, the in fight-control application 104c may also allow the gathering of information (e.g. the capture and recording of images and video using cameras onboard the UAV). For use with weaponized UAVs, the flight-control application 104c can provide controls to activate weapons systems. In one embodiment, the image analysis application 104e receives images/video from the UAV, detects an enemy target, and requests human confirmation (via the flight-control application 104c or other application) before enabling the DBR 100 to issue commands to fire (or not fire) at the target based upon DBR rules and processing of information provided thereto.

The system fault record application 104d may be used to detect faults from the various mission systems, log and report such faults, and/or identify solutions to the faults. Because system faults may occur during any mission phase, the system fault record application 104d is active during the entire mission lifecycle; in other words, the maintenance phase may span all other mission phases.

The image analysis application 104e is used by a mission analyst during the on-mission and/or post-mission phases to analyze intelligence, surveillance, and reconnaissance (ISR) data gathered by the UAV, such as still images and full motion video. In one exemplary embodiment, the image analysis application 104e displays raw ISR data (i.e. data which has not been substantially filtered, compressed, or otherwise altered) to an analyst. However, it will be appreciated that reviewing the vast amount of raw data typically collected is time consuming, labor intensive, and generally inefficient. Thus, in some embodiments, the DBR 100 receives ISR data from the UAV, selects an appropriate screening algorithm based upon the current mission context, and sends the screened ISR data, which can be significantly smaller in size compared to the raw data, to the image analysis application 104e. In embodiments, the image analysis application 104e may perform further image processing to reduce the amount of ISR information that must be reviewed by the analyst.

Referring now to FIG. 2, a DBR 200, which may be the same as or similar to DBR 100 in FIG. 1, includes a context originating entry 202, a reasoner/decision entity 204, and a plurality of enforcement entities 206, with five enforcement entities here being shown in the exemplary embodiment of FIG. 2. Those of ordinary skill in the art, after reading the disclosure herein, will appreciate that fewer or more than five enforcement entities may be used depending upon the needs of a particular application. The entities 202-206 intercommunicate via information paths discussed below. In addition, the DBR 200 may include one or more user interface connections 208, data source inputs (or “data sources” for brevity) 210, and outputs 216, as shown. The user interface connections 208 allow one or more users, such as mission commanders 212, 214, to provide information to the DBR 200, such information including but not limited to, mission requirements, intents, and feedback. The outputs 216 provide data, commands, and requests to the applications 104 (FIG. 1) and/or other mission systems.

The context originating entity 202 generally receives a variety of mission source information and outputs parsed mission policy (e.g. mission plans and context-based rules) to the reasoner/decision entity 204. The parsed policy can include context-based rules, user intent (i.e. commands), reference time for policies to be effective, or any other type of policy information. In the embodiment shown, the context originating entry 202 is comprised of a policy editor 202a, a parser 202b, and an ontology database 202c. In some embodiments, discussed further hereinbelow, the context originating entity 202 also includes a user interface connection 208 to receive input from a user 212.

The mission source information received by the context originating entity 202 can include plans, metrics, strategy, policy, and other documentation and terminology needed to run the mission and may be provided in any electronic form, such as manuals, checklists, and maps. In embodiments, the mission source information is stored within one or more of the databases 102 (FIG. 1). The semantics by which a particular source of information is interpreted is referred to as an “ontology”, and an ontology is generally comprised of one or more “ontological definitions.” Ontological definitions may be entered by the user 212 via the policy editor 202a and/or stored along with the mission source information within the databases 102. The context originating entity 202 can store ontologies within the ontology database 202c for later use.

The policy editor 202a receives intent and feedback information in the form of information commands and/or messages. This information may be derived from previous mission practices approved by the mission governing body, or it may be new information derived from dynamic events that occur during a mission. The policy editor 202a generates new policy by correlating historical intent/feedback information and new intent/feedback information using the ontological definitions stored in the ontology database 202c. In addition, the policy editor 202a may adjust the new policy based on available system resource information from the system resources database 204e. If system resources are not sufficient to execute the present mission policy or policies, then the context originating entity 202 can autonomously generate new policy in accordance with available system resources and command intent.

The parser 202b receives new policy from the policy editor 202a and interprets the new policy's syntax based upon ontological definitions stored in the ontology database 202c and available system resource information from the system resources database 204e. If the parser 202b successfully interprets the new policy syntax (i.e. the syntax is valid), then the parser sends the parsed policy to the reasoner/decision entity 204, thereby enabling the reasoner/decision entity 204 to make decisions based upon events that may occur during the mission. If the syntax is invalid, then the parser 202b rejects the new policy and may notify the policy editor 202a accordingly.

The context originating entity 202 can operate autonomously, semi-autonomously, or manually. In one exemplary embodiment, the user 212 can directly enter mission policy and/or ontological definitions via the policy editor 202a. In another embodiment, the context originating entity 202 primarily uses information stored in the mission databases 102, the ontology database 202c, and the system resources database 204e. In another embodiment, the context originating entity 202 generates parsed mission policy using only information from the mission databases 102, but requires user confirmation before sending the parsed mission policy to the reasoner/decision entity 204.

The reasoner/decision entity 204 (sometimes referred to as the “decision engine”) generally receives parsed mission policy from the context originating entity 202, event data from the data sources 210, and outputs decisions to one or more of the enforcement entities 206. In the embodiment shown, the reasoner/decision entity 204 is comprised of a policy integration module 204a, a policy repository 204b, a context manager 204c, an event collector-analyzer 204d, a system resources database 204e, a system resource manager 204f, an operator enable/override module 204g, a policy translation module 204h, an Event-Condition-Action (ECA) rule translation database 204i, a conflict detection and rule integration module 204j, and an ECA rules database 204k.

The reasoner/decision entity 204 can output various types of decision data. In one embodiment, shown in FIG. 2, the reasoner/decision entity 204 outputs actionable rules, known as ECA rules, which are evaluated by the enforcement entities 206. An ECA rule includes three parts: an event; a condition based upon the event; and an action to take if the condition is met. An exemplary ECA rule for use within a UAV mission states that if an adverse weather (event) is detected during the L&R phase (condition), then an alternative runway that permits the UAV to take off in a direction away from the weather event should be used (action). To evaluate EAC rules, each of the enforcement entities 206 may include targeted rule interpretation and decision-making capabilities.

The policy integration module 204a receives new parsed mission policy from the context originating entity 202, integrates the new policy with existing policy retrieved from the policy repository 204b, and detects conflicts between the new policy and the existing policy. In one embodiment, the integrated policy is sent directly to the context manager 204c. In another embodiment, the integrated policy is stored to the policy repository 204b for retrieval by the context manager 204c. In the later embodiment, the policy integration module 204a may notify the context manager 204b when a new policy is available. If the new mission policy conflicts with existing mission policy (e.g. it would be impossible to satisfy both a new context-based rule and an existing context-based rule), the policy integration module 204a may reject the new policy and/or notify the context originating entity parser 202b of the conflict.

The event collector-analyzer 204d generally receives event data from a variety of data sources 210, aggregates and analyzes the diverse event data, and outputs qualified events to the context manager 204c. Example data sources 210 include: sensors upon a vehicle, such as radar, light radar (LIDAR), and cameras; soft data sources, such as weather reports; or any other mission-relevant data source. The received event data can be indicative of anything that happens during the mission (referred to as “events”), for example an updated weather report, a target detected via vehicle sensors, an unintended object on a runway, a change in average hue across several images taken from a UAV camera, and a UAV component fault. Certain events, referred to as “triggers”, are directly related to one or more context-based rules included within the mission policy. In other words, triggers cause a change in context, as defined by the mission policy. In some embodiments, trigger event data is received separate from SA event data, thereby reducing the event processing required by the event collector-analyzer 204d.

As is known in the art, a particular mission, mission plan, or mission lifecycle phase may depend upon the availability of a specific resource. For example, in an UAV surveillance mission, the on-mission phase requires a UAV, an onboard camera, in addition to other sensors and avionics.

Therefore, in accordance with the concepts and systems described herein, the system resource database 204e and corresponding system resource manager 204f are provided to track the availability of system resources throughout the mission lifecycle. The system resources database 204e can receive resource availability updates from the event collector-analyzer 204d and/or from the user 212 via the system resource manager 204f. For example, a camera on a UAV (which is coupled to a data source 210), may transmit image data to the image analysis application 104e which, in turn, processes the image data to derive events and triggers which are passed to the event collector-analyzer 204d. One such trigger could be an indicator that the camera malfunctioned, in which case the event collector-analyzer 204d can inform the system resource database 204e that the camera is no longer available. In turn, the system resource database 204e provides resource availability information to the context originating entity 202, which parses and edits mission policy based upon the available resources. Turning again to the UAV surveillance example, the context originating entity parser 202b may reject new policy which relies on the camera (e.g. “record camera image data surveillance if UAV is over water”) if the system resource database 204e indicates that the camera is unavailable. Thus, when a resource is not available, the policy execution will not be attempted, thereby saving valuable processing power.

The context manager 204c generally determines which mission policies should be presently activated based upon the current mission context. The mission context may be defined in terms of time and/or qualified events received from the event collector and analyzer. In the exemplary embodiment shown, the context manager 204c receives selected mission policies from the policy repository 204b, receives qualified events from the event collector-analyzer 204d, and outputs newly activated policies, as shown. As discussed above, a mission policy can include one or more context-based rules. Thus, in some embodiments, the context manager 204c determines the policies to be activated by determining the current mission context and, then, identifying those context-based rules which apply to the current context.

In some embodiments, the context originating entity parser 202b, policy integration module 204a, and/or the context manager 204c are/is capable of autonomously deriving new mission policy. As is known in the art, various techniques may be used to derive new mission policy, including: G. Bent, et al., “Distributed Policy Based Access to Networked Heterogeneous ISR Data Sources,” Proc. SPIE, Vol. 7694, 2010 (proposal to use the distributed policy-based access to networked heterogeneous ISR data sources within a coalition environment); T. Pham, et al., “Intelligence, Surveillance, and Reconnaissance Fusion for Coalition Operations,” 11th Intl. Conf Inform. Fusion, June 2008 (policy-aware fusion technique that takes policy into account to enable rapid assembly and dynamic control of ISR assets and associated policy agreements that govern the sharing and dissemination of information to support multiple concurrent coalition missions); and G. E. Collins et al., “A UAV Routing and Sensor Control Optimization Algorithm for a Target Search,” Proc. SPIE, Vol. 6561, 2007 (proposal to use policy in solving the target search problem). It should be appreciated that this derivation capability allows the DRB 200 to adapt changing conditions (i.e. context) not specifically accounted for in documented mission plans and procedures. Further, this derivation capability allows the DBR 200 to resolve certain policy conflicts, such as a conflict detected within the policy integration module 204a, which would necessitate user intervention.

In certain embodiments, the reasoner/decision entity 204 includes an operator enable/override module 204g to allow a user 214 to make real-time policy decisions and/or override policy decisions made by the context manager 204c. Therefore, in one aspect, the systems sought to be protected herein can enhance a user's ability to make real-time decisions by automating tasks that may be defined by a repeatable set of rules while still giving the user a chance to override system decisions. It will be appreciated that the user 212 and the user 214 may be the same individual, such as the mission commander or separate individuals. In other embodiments, the reasoner/decision entity 204 operates autonomously and the operator enable/override module 204g is omitted.

The ECA rule database 204k stores the defined set of ECA rules for given high level policy description statements. The policy translation module 204h examines the new policy and then converts the policy described in high level policy description statements into low level ECA rules. The ECA rule translation database 204i enables the translation of high level statements to existing ECA rules that accomplish the same purpose. The conflict detection and rule integration module 204j resolves all conflicts between new policy and existing rules that are not replaced by the new so policy for the current mission.

In the exemplary embodiment of FIG. 2, each of the enforcement entities 206 is provided to enforce various policies associated with a given mission lifecycle phase. As shown in FIG. 2, the DBR 200 includes five enforcement entities corresponding to the five mission phases: a pre-mission enforcement entity, a L&R enforcement entity, an on-mission enforcement entity, a maintenance enforcement entity, and a post-mission enforcement entity (only the pre-mission entity is shown in detail in FIG. 2). As noted above, any number and type of enforcement entities 206 can be used within the DBR 200.

In general, an enforcement entity 206 receive decisions (e.g. ECA rules) from the reasoner/decision entity 204 and enforces those decisions by outputting data, commands, and requests to the applications 104 (FIG. 1) and/or other mission systems via the output 216. Further, an enforcement entity 206 may receive event data from a data source 210, mission requirements from a user via a user interface connection 208, and resource update notifications from the event collector-analyzer 204d, for use in enforcing decisions. An enforcement entity 206 may be comprised of resources needed to enforce a decision, such as databases, algorithms, and other software or hardware. Such resources may be shared across multiple enforcement entities or specific to an individual enforcement entity.

One or more of the enforcement entities 206 may be active at any given time. For example, during the on-mission phase, it may be necessary to run the maintenance enforcement entity 206, in addition to the on-mission phase enforcement entity, so that in-flight diagnostic checklists can be run. Therefore, the DBR 200 may utilize a processing device capable of performing parallel processing (e.g. a parallel processing computer) wherein multiple enforcement entities 206 (and other entities 202, 204) can execute concurrently. Any concurrent processing techniques may be used, including multithreading, scheduling, and parallel processing. In one embodiment, each enforcement entity 206 is a separate application.

Having described the general operation and structure of an enforcement entity 206, the pre-mission enforcement entity, which is shown in detail FIG. 2, will now be described in detail. The exemplary pre-mission enforcement entity 206 is comprised of a mission requirements database 206a, a configuration manager 2066, an effective rules database 206c, a decision engine 206d, a mission plans database 206e, a resource manager 206f, and a mission resource database 206g.

The configuration manager 206b examines the requirements for the current mission and then examines all possible rules that apply to the mission. These rules include the new rules derived from the reasoner/decision entity 204 and the set of possible historical rules that could be applied to that mission. These rules are previously received from the reasoner/decision entity 204 and stored in the effective rules is database 206c. In one embodiment, the configuration manager 206b receives mission requirements from the user 212 and stores the requirements in the mission requirements database 206a.

The decision engine 206d integrates inputs from all other entities in order to determine if it needs to modify the existing mission plan so that the new plan satisfies the mission events and associated context of those events. In the embodiment shown in FIG. 2, the decision engine 206d is configured to receive mission requirements from the configuration manager 206b, receive mission policy or ECA rules from the effective rules database 206c, receive system resource information from the resource manager 206f, and generate a mission plan. During the mission, the reasoner/decision entity 204 may pass the new policy for the revised mission plan to the enforcement entity 206 which, in turn, would output a revised mission plan 216 to the mission planner 104a (FIG. 1) for execution. It should be appreciated that the mission plans database 206e may be included within the mission planner 104a (FIG. 1).

The resource manager 206f and mission resource database 206b operate similar to the system resource manager 204f and system resources database 204, respectively, which are described hereinabove.

Having described in detail the architecture of the DBR 200, it should now be appreciated that, in one embodiment, the DBR is capable of generating a mission plan based upon user-specified requirements, mission policy from a variety of sources, and dynamic mission context.

FIG. 3 shows an exemplary computer 300 that can perform at least part of the processing described herein. The computer 300 includes a processor 302, a volatile memory 304, a non-volatile memory 306 (e.g., hard disk), an output device 308 and a graphical user interface (GUI) 310 (e.g., a mouse, a keyboard, a display, for example). The non-volatile memory 306 stores computer instructions 312, an operating system 314, and data 316, each of which is coupled together by a bus 318. In one example, the computer instructions 312 are executed by the processor 302 out of volatile memory 304. In one embodiment, an article 320 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

All references cited herein are hereby incorporated herein by reference in their entirety.

Having described exemplary embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A data broker-reasoner (DBR) system comprising:
a context originating entity for receiving mission source information from one or more information sources and for outputting a mission policy;
a reasoner/decision entity, coupled to the context originating entity, for receiving a new mission policy from the context originating entity, for receiving event data, for determining an enforcement rule based upon the new mission policy and the event data, and for outputting the enforcement rule; and
one or more enforcement entities, coupled to the reasoner/decision entity, for receiving an enforcement rule from the reasoner/decision entity and executing the received enforcement rule.

2. The system of claim 1 wherein the context originating entity comprises:
an ontology database configured to store ontologies;
a parser coupled to the ontology database and configured to fetch ontologies from the ontology database; and
a policy editor coupled to the ontology database and the parser, the policy editor operable to receive intent commands from a user, generate an ontology based upon the intent commands, generate a mission policy based upon the intent commands and the ontology, and send the policy to the parser.

3. The system of claim 1 wherein the reasoner/decision entity comprises:
a policy database; and
a policy integration module coupled to the policy database and configured to receive the new mission policy, fetch an existing mission policy from the policy database, and integrate the new mission policy with the existing mission policy.

4. The system of claim 3 wherein the reasoner/decision entity further comprises:
an event collector-analyzer for receiving event data from one or more data sources; and
a context manager, coupled to the policy integration module and the event collector-analyzer, for receiving a plurality of mission policies from the policy integration module, for receiving event data from the event collector-analyzer, for selecting one of the plurality of mission policies to be enforced, and for outputting an enforcement rule associated with the selected mission policy.

5. The system of claim 1 wherein at least one of the enforcement entities comprises:
a mission requirements database;
a configuration manager, coupled to the mission requirements database, to receive mission requirements from a user and to store the mission requirements in the mission requirements database;
a resource manager to manage resources information;
a mission plans database configured to store mission plans; and
a decision engine, coupled to the configuration manager, the mission plans database, and the resource manager, the decision engine configured to receive current requirements from the configuration manager, receive resource information from the resource manager, fetch a plurality of mission plans from the mission plans database, and select one of the plurality of mission plans based upon the current requirements and the resource information.

6. The system of claim 1 wherein each of the enforcement entities correspond to a mission lifecycle phase.

7. The system of claim 5 wherein the at least one enforcement entity further comprises an effective rules database coupled to receive rules updates from the configuration manager and coupled to provide rules to the decision engine.

8. The system of claim 5 wherein the at least one enforcement entity further comprises a mission-related resources database coupled to provide resource information to the resource manager and to receive resource information updates from the resource manager.

9. The system of claim 4 wherein the reasoner/decision entity further comprises:
a system resource data source;
a system resource manager coupled to the system resource database and the system resource data source, the system resource manager operable to receive resource information from the system resource data source; and
a system resources database coupled to the system resource manager, the policy integration module, and the event collector-analyzer, the system resources database operable to receive resource updates from the event collector-analyzer, resource reservations from the policy integration module, resource updates from the system resources manager, and to provide available resource information to the policy editor and the parser.

10. The system of claim 9 wherein the reasoner/decision entity further comprises:
an Event-Condition-Action (ECA) rule translation database;
a rules database;
a policy translation module coupled to receive defined rules from the ECA rule translation database and coupled to receive one or more newly active policies from the context manager; and
a conflict detection and rule integration module coupled to provide updated rules to and receive existing rules from the rules database, coupled to receive ECA rules from the policy translation module, and coupled to provide feedback to the context manager.

11. The system of claim 10 further comprising an operator enable/override module coupled between the context manager and the policy translation module, the operator enable/override module operable to allow a user to make real-time policy decision and override policy decisions made by the context manager.

12. A mission planning system, comprising:
one or more mission lifecycle databases;
one or more mission applications; and
a data broker-reasoner (DBR) system coupled to the mission lifecycle databases and to the mission applications, the DBR system comprising:
a context originating entity for receiving mission source information from one or more information sources, including at least one of the mission lifecycle databases, and for outputting a mission policy to at least one of the mission applications;
a reasoner/decision entity, coupled to the context originating entity, for receiving a new mission policy from the context originating entity, for receiving event data, for determining an enforcement rule based upon the new mission policy and the event data, and for outputting the enforcement rule; and
one or more enforcement entities, coupled to the reasoner/decision entity, for receiving an enforcement rule from the reasoner/decision entity and executing the received enforcement rule.

13. The system of claim 12 wherein the context originating entity comprises:
an ontology database configured to store ontologies;
a parser coupled to the ontology database and configured to fetch ontologies from the ontology database; and
a policy editor coupled to the ontology database and the parser and configured to receive intent commands from a user, generate an ontology based upon the intent commands, generate a mission policy based upon the intent commands and the ontology, and send the policy to the parser.

14. The system of claim 12 wherein the reasoner/decision entity comprises:
a policy database; and
a policy integration module coupled to the policy database and configured to receive the new mission policy, fetch an existing mission policy from the policy database, and integrate the new mission policy with the existing mission policy.

15. The system of claim 14 wherein the reasoner/decision entity comprises:
an event collector-analyzer for receiving event data from one or more data source; and
a context manager, coupled to the policy integration module and the event collector-analyzer, for receiving a plurality of mission policies from the policy integration module, for receiving event data from the event collector-analyzer, for selecting one of the plurality of mission policies to be enforced, and for outputting an enforcement rule associated with the selected mission policy.

16. The system of claim 12 wherein at least one of the enforcement entities comprise:
a mission requirements database;
a configuration manager, coupled to the mission requirements database, to receive mission requirements from a user and to store the mission requirements in the mission requirements database;
a resource manager to manage resources information;
a mission plans database configured to store mission plans; and
a decision engine, coupled to the configuration manager, the mission plans database, and the resource manager, the decision engine configured to receive current requirements from the configuration manager, receive resource information from the resource manager, fetch a plurality of mission plans from the mission plans database, and select one of the plurality of mission plans based upon the current requirements and the resource information.

17. The system of claim 12 wherein each of the enforcement entities correspond to a mission lifecycle phase.

18. The system of claim 16 wherein the at least one enforcement entity further comprises an effective rules database coupled to receive rules updates from the configuration manager and coupled to provide rules to the decision engine.

19. The system of claim 18 further comprising a mission-related resources database coupled to provide resource information to the resource manager and to receive resource information updates from the resource manager.

20. The system of claim 15 wherein the reasoner/decision entity further comprises:
a system resource data source;
a system resource manager coupled to the system resource database and the system resource data source, the system resource manager operable to receive resource information from the system resource data source; and
a system resources database coupled to the system resource manager, the policy integration module, and the event collector-analyzer, the system resources database operable to receive resource updates from the event collector-analyzer, resource reservations from the policy integration module, resource updates from the system resources manager, and to provide available resource information to the policy editor and the parser.
